(19) United States
(12) Patent Application Publication
(10) Pub. No.: US 2026/0173099 A1
(43) Pub. Date: Jun. 18, 2026

(54) USER EQUIPMENT AND NETWORK ENTITY WITH REPORT CONFIGURATION MESSAGE FOR CHANNEL MEASUREMENT AND REPORTING AT THE UE

(71) Applicant: FRAUNHOFER-GESELLSCHAFT ZUR FOERDERUNG DER ANGEWANDTEN FORSCHUNG E.V., Muenchen (DE)

(72) Inventors: Mohammad ALAWIEH, Erlangen (DE); Georgios KONTES, Erlangen (DE); Birendra GHIMIRE, Erlangen (DE); Ernst EBERLEIN, Erlangen (DE)

(21) Appl. No.: 19/532,465

(22) Filed: Feb. 6, 2026

Related U.S. Application Data
(63) Continuation of application No. PCT/EP2024/072606, filed on Aug. 9, 2024.

(30) Foreign Application Priority Data
Aug. 10, 2023 (EP) 23190931.8

(51) Int. Cl. H04W 72/23

(52) U.S. Cl. CPC H04W 72/23

(57) ABSTRACT

User equipment (or TRP) having a transceiver configured to perform a measurement and/or channel estimation on a reference signal with respect to a plurality of properties, especially with to a plurality of paths; wherein the user equipment (or TRP) is configured to receive a report configuration message (e.g. from a network entity, e.g. LMF, gNB); wherein the transceiver is configured to report on the measurement and/or channel estimation by use of a report, wherein the report is reduced to one or more limited and/or defined properties and/or paths in accordance to the report configuration message.

### CROSS-REFERENCE TO RELATED APPLICATIONS

This application is a continuation of copending International Application No. PCT/EP 2024/072606, filed Aug. 9, 2024, which is incorporated herein by reference in its entirety, and additionally claims priority from European Application No. 23190931.8, filed Aug. 10, 2023, which is also incorporated herein by reference in its entirety.

### TECHNICAL FIELD

Embodiments of the present invention refer to a user equipment and to a corresponding network entity. Further embodiments refer to methods for operating the user equipment and/or the network entity and to a corresponding computer programs. In general, embodiments of the present invention are in the field of feedback or measurement configuration based on channel information.

### BACKGROUND OF THE INVENTION

FIG. 3 is a schematic representation of an example of a terrestrial wireless network 100 including, as is shown in FIG. 3(a), the core network 102 and one or more radio access networks RAN₁, RAN₂, . . . RAN_{N}. FIG. 3(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device.

The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 3(b) shows an exemplary view of five cells, however, the RANₙ may include more or less such cells, and RANₙ may also include only one base station. FIG. 3(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 3(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 3(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 3(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 3 may be a heterogeneous network having distinct overlaid networks, e.g., a network of macro cells with each macro cell including a macro base station, like base station gNB₁ to gNB₅, and a network of small cell base stations, not shown in FIG. 3, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 3, for example in accordance with the LTE-Advanced Pro standard or the 5G or NR, new radio, standard.

In mobile communication networks, for example in a network like that described above with reference to FIG. 3, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 3. This is referred to as an “in-coverage” scenario. Another scenario is referred to as an “out-of-coverage” scenario. It is noted that “out-of-coverage” does not mean that the two UEs are not within one of the cells depicted in FIG. 3, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 4 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 3. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 5 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 5 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 4, in addition to the NR mode 1 or LTE mode 3 UEs 202, 204 also NR mode 2 or LTE mode 4 UEs 206, 208, 210 are present. In addition, FIG. 5, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 4 and FIG. 5 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

For a plurality of applications like position determination and/or resource adaption a so-called channel estimation or in general a measurement on channel characteristics is performed. There are a lot of standard procedures to perform channel estimation, e.g., dependent on the direct Line-of-Sight path or a reflected Line-of-Sight path. Furthermore, the reporting is also standardized. However, for different applications different information, i.e., different measurement and different reporting would be beneficial.

### SUMMARY

An embodiment may have a user equipment having: a transceiver configured to perform a measurement and/or channel estimation on a reference signal with respect to a plurality of properties, especially with respect to a plurality of paths; wherein the user equipment is configured to receive a report configuration message; wherein the transceiver is configured to report on the measurement and/or channel estimation by use of a report, wherein the report is reduced to one or more limited and/or defined properties and/or paths in accordance to the report configuration message.

Another embodiment may have a transmission Point, TRP, having: a transceiver configured to perform a measurement and/or channel estimation on a reference signal with respect to a plurality of properties, especially with respect to a plurality of paths; wherein the TRP is configured to receive a report configuration message; wherein the transceiver is configured to report on the measurement and/or channel estimation by use of a report, wherein the report is reduced to one or more limited and/or defined properties and/or paths in accordance to the report configuration message.

Another embodiment may have a network entity having: a transceiver configured to receive a report on a measurement and/or channel estimation on a reference signal with respect to a plurality of properties, especially with respect to a plurality of paths, wherein the report is reduced to one or more limited and/or defined properties and/or paths in accordance to a report configuration message, wherein the transceiver is configured to provide the report configuration message.

Another embodiment may have a communication system having a user equipment according to the invention as mentioned above or TRP according to the invention as mentioned and a network entity according to the invention as mentioned.

According to another embodiment, a method for operating a user equipment may have the steps of: performing a measurement and/or channel estimation on a reference signal with respect to a plurality of properties, especially with to a plurality of paths; receiving a report configuration message; reporting on the measurement and/or channel estimation by use of a report, wherein the report is reduced to one or more limited and/or defined properties and/or paths in accordance to the report configuration message.

According to another embodiment, a method for operating a network entity or user equipment may have the steps of: receiving a report on the measurement and/or channel estimation on a reference signal with respect to a plurality of properties, especially with to a plurality of paths, wherein the report is reduced to one or more limited and/or defined properties and/or paths in accordance to a report configuration message; and providing the report configuration message.

Another embodiment may have a non-transitory digital storage medium having stored thereon a computer program for performing the method according to the invention as mentioned above, when the computer program is run by a computer.

Embodiments of the present invention provide a user equipment (or TRP) comprising a transceiver. The transceiver is configured to perform a measurement and/or a channel estimation on a reference signal (like a beacon signal) with respect to a plurality of properties. For example, the measurement/channel estimation can be performed with respect to a plurality of paths. The user equipment (or TRP) is configured to receive a report configuration message (e.g., from a network entity like an LMF or the gNB) and to report on the measurement and/or channel estimation by use of a report. The report is reduced to one or more limited and/or defined properties and/or paths in accordance to the report configuration message.

Another embodiment provides a network entity, like a LMF, gNB, network coordinator or NWDAF comprising a transceiver configured to receive a report on the measurement and/or channel estimation on a reference signal with respect to a plurality of properties, especially with respect to a plurality of paths. Here, the report is reduced to one or more limited and/or defined properties and/or paths in accordance to a report configuration message. For this, the transceiver is configured to provide the report configuration message. Note, according to further embodiments, the transceiver can also be part of a user equipment using the report and outputting the report configuration message.

A further embodiment provides a communication system comprising a user equipment and the network entity.

Another embodiment refers to a method for operating a user equipment comprising the steps
performing a measurement and/or channel estimation on a reference signal with respect to a plurality of properties, especially with to a plurality of paths;
receiving a report configuration message (e.g. from a network entity);
reporting on the measurement and/or channel estimation by use of a report, wherein the report is reduced to one or more limited and/or defined properties and/or paths in accordance to the report configuration message.

Another embodiment refers to a method for operating a network entity or user equipment comprising the two steps:
receiving a report on the measurement and/or channel estimation on a reference signal with respect to a plurality of properties, especially with to a plurality of paths, wherein the report is reduced to one or more limited and/or defined properties and/or paths in accordance to a report configuration message; and
providing the report configuration message.

According to embodiments the method may be computer implemented.

### BRIEF DESCRIPTION OF THE DRAWINGS

Below, embodiments will subsequently be discussed referring to the enclosed figures, wherein:

FIG. 1a shows a schematic representation of the signaling procedure between a measuring UE reporting channel information and a network entity according to embodiments;

FIG. 1b gives an overview to the functional building blocks;

FIG. 2a shows a schematic diagram to illustrate an example CIR scenario;

FIG. 2b shows schematically InF-LOS CIR generated with ray-tracing;

FIG. 3a/b show schematic representations of a terrestrial wireless network (FIG. 3a a core network communicating with a plurality of RANs, FIG. 3b a plurality of gNB communicating with a plurality of UEs) to illustrate background of the embodiment;

FIG. 4 shows a schematic representation of an in-coverage scenario;

FIG. 5 shows a schematic representation of an out-of-coverage scenario; and

FIG. 6 shows a schematic representation illustrating embodiments implemented as computer program according to embodiments.

### DETAILED DESCRIPTION OF THE INVENTION

Below, embodiments of the present invention will subsequently be discussed referring to the enclosed figures, wherein identical reference numerals are provided to objects having identical or similar function, so that the description thereof is interchangeable and mutually applicable.

Before discussing embodiments of the present invention in detail, the background of the present invention will be described.

When considering channel estimation the transmitter usually sends pilot signal(s) at a given time or at known intervals, the receiver uses these pilot signals to estimate the channel characteristics at those intervals. For reporting, one option is to consider a full channel information: In this method, the receiver will provide the complete CIR information. The second option is reduced channel information, here a smaller number of measurements or estimates are used to represent the relevant parts of the channel.

This application focuses on compressed channel sounding. Some parts (reporting and feedback) of the solution are applicable to blind channel estimation: in which the receiver relies on statistical properties of the received signal to estimate the channel characteristics without using any known pilot signals. When a device or reduces/compress the channel information, this may result in the loss of some information, which can affect the accuracy and reliability of the wireless system. It can also increase the latency of the system, as additional configurations and processing is entailed to resolve the relevant missing data.

From another perspective, the entity requesting the measurement might not be aware of information related to the reported paths. In a simple example, A User Equipment (UE) in a wireless communication system detects 16 different paths in the channel impulse response (CIR) data, but is configured only report 8 of them. The UE develops a criteria to select the 8 most important paths to report based on the available data; such as
Path Power: The UE can select the 8 paths with the highest power levels in the CIR data, as these paths are likely to be the strongest and most reliable. Delay Spread: The UE can select the 8 paths with the most significant delay spread, as these paths are likely to provide diversity in the channel and improve the overall reliability of the communication.
Directionality: The UE can select the 8 paths with the most consistent directionality, as these paths are likely to provide a stable and predictable channel for communication.
Frequency Response: The UE can select the 8 paths with the most consistent frequency response, as these paths are likely to provide a stable and reliable channel for communication.
Channel Correlation: The UE can select the 8 paths with the least correlation between each other, as these paths are likely to provide the most diversity and improve the overall reliability of the communication.

However if the report receiver may not be able to accurately estimate the channel parameters and optimize the transmission parameters for reliable communication. This can result in a lower quality of service or even a complete breakdown in the wireless communication between the UE and the base station.

For example, if the UE selects paths based on path power and the receiver assumes that the paths are selected based on delay spread, the receiver may optimize the transmission parameters for a different set of paths than those actually being used by the UE. This can result in suboptimal performance or even communication failure.

Below, the background and especially the usage of the delay information based on channel measurement (CIR/PDP/DP) will be discussed

In wireless communication, a delay path (DP) and angular path (AP) refers to a path and direction that a signal takes to reach the receiver after being transmitted from the transmitter. The signal can take multiple paths due to reflections, diffraction, and scattering in the environment. Each path has a different delay, amplitude, and phase shift, and can arrive at the receiver at different times. These delay paths can cause interference, fading, and multipath propagation, which can affect the quality and reliability of the wireless communication.

When the Power (or attenuation) information is used, the delay paths can be characterized using the power delay profile (PDP) of the wireless channel, which shows the distribution of power over time delay.

On the other end, a channel impulse response (CIR) is a function that describes the response of a communication channel to an impulse input. It characterizes how the channel affects the input signal in terms of delay, attenuation, and phase shift.

The channel information including delay measurement such CIR, DP or PDP are relevant for:
Positioning use cases which can depend on additional paths (i.e. additional to the first arrival path).
Channel Sensing which may use the information for dynamic spectrum sharing, advanced interference management, and the use of AI/ML to predict and adapt to changes in the channel conditions. This information can be used to improve the accuracy of the receiver's signal processing, such as demodulation and decoding. Joint communication and sensing (JCAS) or integrated communication and sensing (ICAS) is a technology that integrates channel sensing information to enhance or enable communication.
Channel Equalization: The CIR provides information about the distortion, delay, and phase shift that the wireless channel introduces to the transmitted signal. This information can be used to design equalizers that compensate for these effects and improve the quality and reliability of the received signal. The CIR can for example be used to estimate the channel response and identify the different delay paths or multipath components of the channel.
Beamforming: The CIR can be used to design beamforming techniques that adapt the antenna array to the channel response and improve the signal-to-noise ratio (SNR) and the throughput of the wireless communication.

According to embodiments, it has been found out that the application might have an influence to the question which properties and especially which paths (reception paths) are reported. For example, the UE can select the angular or delay paths by identifying the peaks in the power delay profile (PDP) of the measured channel. These peaks correspond to the different delay paths or multipath components of the channel. To differentiate between signal and noise, the UE can apply a threshold to the PDP, such that only the paths with power above the threshold are considered. The threshold can be adaptive based on the noise level and the signal-to-noise ratio (SNR) of the received signal. Additionally, the UE can use techniques such as averaging or smoothing to reduce the effect of noise on the measured channel in the DP, DPD or CIR information selection.

The UE can select a part of the CIR based on a specific time window or frequency range. The server can provide instructions to the UE on what part of the CIR to report, such as the peak amplitude or delay. Based on the reported CIR, the server can use techniques such as time of arrival (TOA), time difference of arrival (TDOA: DL-TDOA, SL-TDOA or UL-TDOA), or angle of arrival (AOA) to estimate the position of the UE. The UE can also report other channel parameters, such as the signal-to-noise ratio (SNR) or the channel quality indicator (CQI), to assist the server in making a more accurate position estimate.

To enable a proper reporting, the UE according to a basic embodiment is configured to perform a measurement and/or channel estimation on a reference signal like a beacon signal with respect to a plurality of properties and/or especially with respect to a plurality of (reception) paths. Furthermore, the UE receives a reporting configuration messages, e.g., from the user of the report, like an LMF or MWDAF (general network entity). Based on the performed measurements/channel estimation and the report configuration message the UE performs reporting on the measurement and/or channel estimation by use of a report. The report is focused or reduced to one or more limited or defined or predefined properties and/or paths in accordance to the report configuration message. According to embodiments the measurement device performing the above described method/reporting can also be another entity, like a TRP.

Starting from this, the solution targets and method performed by a measurement device (UE/TRP):
the device receives a report configuration message, the message include information to request from the device report reduced channel information, the information includes at least one additional path associated with a multipath reception;
the UE receiving assistance data to enable the UE measure the reference signals;
the UE measuring one or more resources on pilot signals or reference signals included in the assistance data;
the UE identifying the one or more additional paths and reporting according to the configuration message information on the one or more additional paths;
the UE providing additional information related to the reports additional path(s) [estimation method] and/or missing (unreported) parts [score or reporting setting].

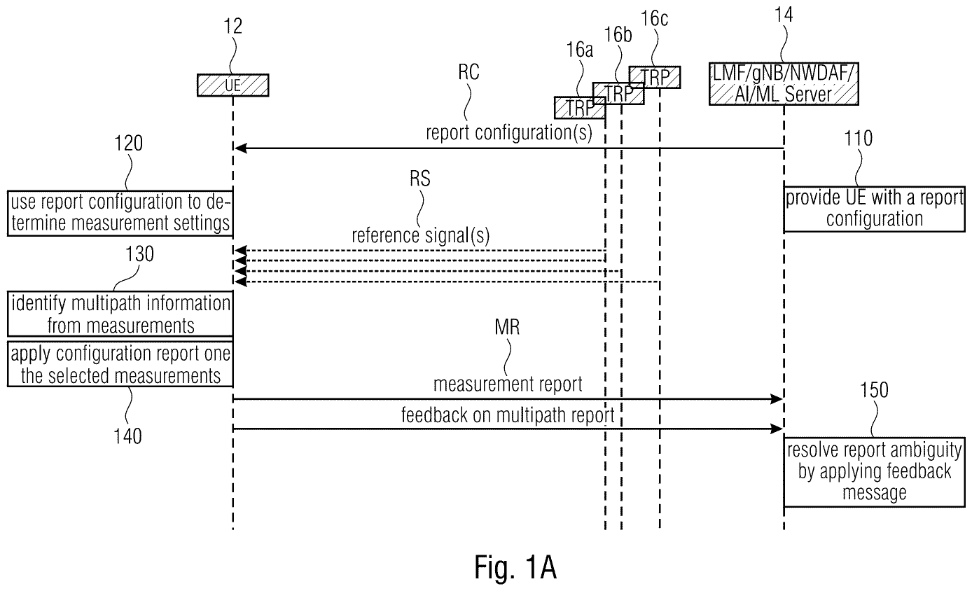

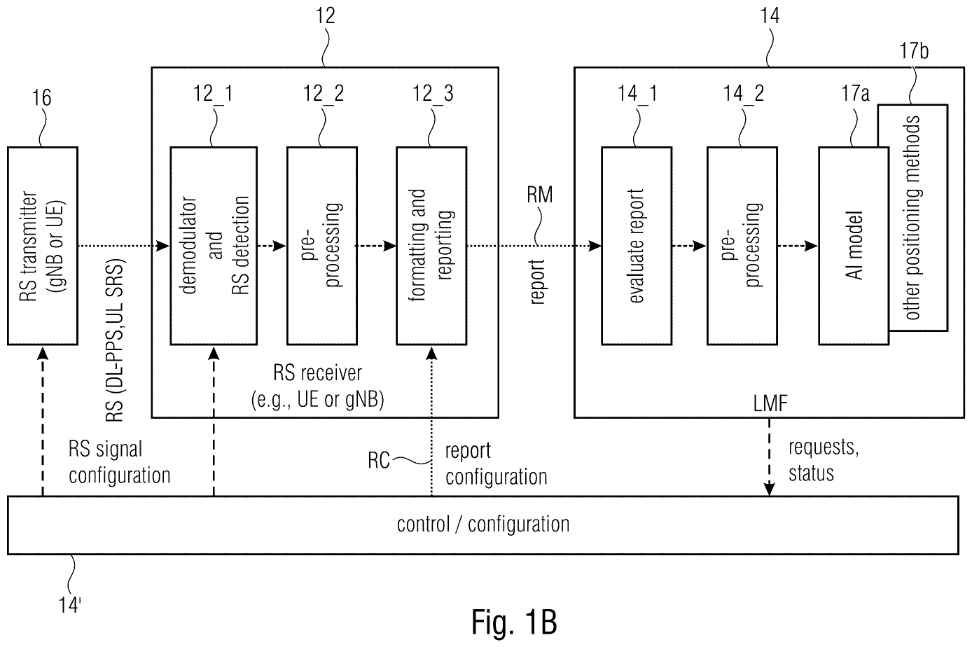

This principle will be discussed with respect to FIG. 1a illustrating a signaling and procedure between a measuring UE reporting channel information and a UE providing the report configuration message. The example of FIG. 1a shows UE 10 communicating with a network entity 14, like an LMF/gNB/MWDAF/AI/ML server. The communication is performed via one or a plurality of TRPs which are marked by the reference numerals 16a, 16b and 16c.

The network entity 14 provides the report configuration RC to the UE 10. The step is marked by the step 110. The UE report configuration is used to determine measurement settings according to an optional variant (cf. step 120). After that the measurement is performed, e.g., based on reference signals RS which are provided by the TRP 16a, 16b and 16c. Starting from the report configuration RC multipath information from the measurements can be identified (cf. step 130). Then in the step 140 the configuration report is applied on the selected measurements. Then the measurement report MR and optionally a feedback on the multipath report is provided to the network entity 14 by the UE 12. According to an optional variant the network entity 12 can resolve report ambiguity by applying the feedback message. In other words, the embodiment of FIG. 1 can be described as an example for entities and signaling in a downlink measurement scenario. An entity 14 request from the UE 10 a report configuration RC on the channel information. For example, for positioning applications. For positioning applications, the entity 14 can reside in the core (example LMF, NWDAF) or in the RAN (example gNB, CU, DU) entity 14 or even not be a part of the system such as an AI/ML entity 14 interacting with the wireless communication system. The UE 12 in this example, measures the one or more DL resources transmitted from the one or more TRPs 16a, 16b and 16c. The UE 12 provides in addition to measurement report MR feedback on the multipath according to the configurations and identified channel characteristics.

Below, the reporting configuration will be discussed in detail. According to an embodiment identified by the UE/TRP the number of/size of (CIR/PDP/DP) information that are applicable can be performed. The report receiving entity (e.g. Base Station, LMF, NWDAF . . . ): sends a report configuration message to the measuring device (UE/TRP), requesting reduced channel information that includes at least one additional path associated with a multipath reception. The message includes size of the CIR information that the report receiving device can handle, which can be related to either a single report or multiple reports associated with multiple resources and/or time instants. The size is identified by the entity based on the report receiving device's capability and/or environmental knowledge. In the case of multiple reports, the size can be either the total size of all reports combined or the maximum size of each individual report.

The size can be the maximum size or a configured static size. In this case the maximum size is used to ensure that the measuring device does not send more CIR information than the report receiving device can handle.

The report configuration message could include a parameter that limits the number of reports that the measuring device can send within a certain time window. The limitation can be applied per single or multiple resource. This approach would ensure that the report receiving device is not overwhelmed with too much data reporting, which can be applicable depending different RRC states of the device (idle, inactive or active) or based on the device aspects such as mobility or identified channel changes.

According to embodiments the report receiving entity can provide a configuration which enables segment-wise reports (also referred to as sample-wise reports). By subdividing the full CIR data into more focused, ‘high-interest’ segments like the first arriving paths or the paths with the highest power. Additionally, each of these segments can be associated with individual reporting configuration or different parameters compared with other segments. One example is to report phase information of the first arriving paths, or to allow averaging over multiple measurements on certain segments. This could reduce the total size of the CIR information that needs to be transmitted and processed, which would improve efficiency. According to embodiments, the transceiver is configured to perform a multiple measurements on certain segments or samples, wherein each of these segments may according to further embodiments, be associated with individual reporting configuration. I.e. the measurement is composed of Nt′ samples of the estimated channel response, e.g. in time domain. The corresponding measurement (e.g., power if reported) corresponds to the measurement for the reported Nt′ samples.

Upon receiving the report configuration message, the measuring device (UE/TRP) will send reduced channel information that includes at least one additional path associated with a multipath reception. The measuring device ensures that the CIR information sent does not exceed the maximum size specified in the report configuration message, which can be related to either a single report or multiple reports associated with multiple resources and/or time instants.

According to embodiments a identifying by measurements UE/TRP the number of/size of [CIR/PDP/DP] information that are required (according to certain channel conditions: dynamic configuration) may be performed.

Given the dynamic and adaptable wireless communication system, the configuration can allow the reporting device to modify its CIR reporting based on certain network conditions. This can involve varying the level of detail in the CIR information reported in real-time, based on factors like Line-of-Sight (LoS) or Signal-to-Interference-plus-Noise Ratio (SINR).

Hence, reducing unnecessary usage and allows for more detailed reports when required. To achieve this, a dynamic CIR reporting configuration can be provided to the reporting device. The dynamic configuration enable the measurement device to from an appropriate configuration a dynamic CIR reporting, and adaptation based on feedback and/or real-time network monitoring. The device then generates and sends the CIR report according to the selected configuration, with the detail level and focus areas varying based on the selected configuration. The device can also adjust its reporting strategy based on feedback from the network or the entity receiving the report.

Additionally, when dynamic configuration is activated, the measurement device shall monitor from the measurement the conditions indicated such as parameters like LoS and SINR. Based on these conditions, the device selects a configuration that matches the current needs of the network or the entity receiving the report. For example, in high-SINR or clear LoS conditions, a more simplified CIR report might suffice, as there would be less multipath propagation or interference. However, in low-SINR or nLoS conditions, a more detailed CIR report could be beneficial depending on the positioning, communication or sensing usages.

Below, optional features will be discussed.

According to embodiments, the user equipment is configured to select and report the relevant parts of a measurement according to parameters received from a network entity (e.g., LMF or gNB).

According to embodiments, the reference signal received by the transceiver comprises multipath reception signal including at least one additional path.

According to embodiments, the report configuration message includes information on the plurality of paths and/or on the number of paths and/or further information than the number of paths.

According to embodiments, the report comprises the measurement and/or the channel estimation for at least one additional path associated with a multipath reception.

According to embodiments, the user equipment (or TRP) estimates the channel impulse response (CIR) and wherein the configuration parameter for selecting the relevant parts of the measured CIR includes one or several of the following parameters:
path power
path power relative to noise power-power of a group of paths (cluster) ratio between peak value to average value within a configurable averaging length-delay and/or delay range-delay spread-path power relative to the slope of the power delay profile-type of power delay profile and related parameter-type of cluster.

According to embodiments, the transceiver configured to perform a measurement and/or channel estimation on a reference signal with respect to at least two, three or more paths; wherein the transceiver configured to select a reduced number of paths for the report based on criteria, like cluster of paths.

A cluster in this context refer to a collection of multipath that would have similar properties. In a single bounce condition, the multipath are likely to be reflected off the same surface and are hence subject to the same physical conditions.

“Cluster of paths” typically refers to a group of paths that have similar properties, such as their delay spread or angle of arrival. Within each cluster, the UE (or TRP) might have multiple individual multipath components, each comprising one or more reflections.

According to embodiments, the transceiver is configured to perform sample-based measurements or sample-based measurements where the timing information is an integer multiple of sampling periods.

According to further embodiments, the transceiver is configured to perform path-based measurements or path-based measurement, where the timing information is according to the detected path timing and may not be an integer multiple of sampling periods.

Background is that AI/ML based positioning, regarding the time domain channel measurements, may be used: Here, some alternatives exit:
Alternative (a): Sample-based measurements, where the timing information is an integer multiple of sampling periods.
Alternative (b): Path-based measurements, where the timing information is according to the detected path timing and may not be an integer multiple of sampling periods.

The issues to be studied include, but not limited to, the following:
Tradeoff of positioning accuracy and signaling overhead;
Impact and necessary details of gNB/UE implementation to obtain the channel measurement values;
Whether the same Alternative(s) applies to all cases or not;
Applicability and necessity of specifying the Alternative(s) to different cases;
Note: different sub-cases may have different issues.

It should be noted that in addition to timing information, the components for the channel measurement for model input may also include power and potentially phase. To provide the type of the channel measurement in their investigation.

Due to the physical layout and characteristics of the environment, some of the paths will have similar lengths or take similar angles. For example, a signal is reflected off a nearby building generating plurality of paths, which reach the receiver with a similar delay and angle. These pluralities of paths are considered part of the same cluster.

A UE might interpret a bouncing signal with a very similar delay and angle as part of the same cluster. If a car and the building are in roughly the same direction relative to the receiver and the reflected signals arrive at the receiver with similar delays, the receiver might not be able to distinguish the path from the car from the paths from the build-ing. In that case, the receiver could group these paths together into the same cluster, even though they come from different objects.

The UE can track the clusters behavior over time to improve the accuracy of the multipath cluster estimation. As the environment changes or the UE moves, the properties of the multipath clusters (such as their delay and direction) will change. By observing these changes, the receiver can get a better understanding of the structure of the multipath environment.

In a related aspect, the UE can exploit the delay and direction (or angle) information of the multipath components. This information can help the UE distinguish between different multipath clusters and correctly group the multipath components. For instance, multipath components that have similar delays and directions are more likely to come from the same object and should thus be grouped into the same cluster.

According to embodiments, the UE sorts the multipath components based on delay and/or angle properties.

According to embodiments, the components with similar delays and angles are grouped together; alternatively or additionally the transceiver is configured to sort the components into clusters.

According to embodiments, the transceiver is configured to track the cluster properties over multiple measurement instants.

According to embodiments, the transceiver is configured to adapt its cluster and/or path estimation reporting based on the identified clusters and/or Doppler shift; alternatively or additionally the transceiver is configured to continually update the channel estimation, cluster identification, and tracking processes to keep up with any changes in the environment.

According to embodiments, each (additional) path is represented by a set of parameters including at least one of the following:
delay,
angle of arrival,
angle of departure,
power;
phase information.

According to embodiments, the transceiver is configured to apply thresholding to select multipath components above a certain threshold.

According to embodiments, the transceiver is configured to select one or more peaks associated with the strongest paths to represent the cluster.

According to embodiments, the transceiver is configured to average and/or sum properties of the measured paths within each cluster to estimate the overall properties of the cluster.

According to embodiments, the transceiver is configured to fit a model to represent a given cluster (which can a certain mathematical or trained distribution from similar representative (offline and/or online collected) data).

According to embodiments, the transceiver is configured to provide additional measurements, like variance to indicate a spread in delay, angle, power and/or phase for the identified components.

In the context of sensing and positioning, different clusters can typically categorized based on their arrival time at the receiver. The first cluster usually contains the Line-of-Sight (LoS) path (if it exists) and any early reflections, such as those from the ground or nearby objects. These early-arriving multipath components can have a significant impact on the received signal and thus it's often beneficial to have a detailed representation of these clusters. Later clusters resulting from multipath components that have undergone more reflections or have travelled longer paths might have less information needed by the report receiving entity. For the later clusters, an abstract representation might be sufficient.

According to embodiments, the transceiver is configured to identify cluster lifetime and to account the dynamic environment in the report according to configuration (NW might instruct UE to report, ignore or notify) and/or according to report size (UE might decide not include some dynamic clusters in case the size of the reporting window is small).

According to embodiments, the transceiver is configured to identify the changes in cluster (new dominant cluster, birth or death) and to account the dynamic environment in the report according to configuration.

According to embodiments, the transceiver configured to reduce content, especially a number of paths for the report, based on criteria comprising:
paths being likely to be the strongest and most reliable;
delay spread, e.g. paths comprising most significant delay spread;
directionality, e.g. paths comprising most consistent directionality;
frequency response, paths comprising most consistent frequency response;
channel correlation, e.g. paths correlating with each other;
cluster of paths.

According to embodiments, the report comprises information related to missing or unreported property or parts.

According to embodiments, the transceiver comprises a calculator configured to determine feedback whether the report configuration is sufficient for reporting on the current situation, e.g. network condition or measurement capability; and/or for a determined reliability or representability.

According to embodiments, the transceiver is configured to request a different repot configuration or a report configuration out a set of report configurations or a larger CIR.

According to embodiments, the transceiver comprises a calculator configured to calculate a score indicative for a reliability or representability of the report for a total measurement and/or channel estimation; or
wherein the transceiver comprises a calculator configured to calculate a score indicative for a reliability or representability of the report for a total measurement and/or channel estimation and wherein the report comprises the score.

According to embodiments, the calculator comprises a threshold for the score below which the report is enhanced by the score; or
wherein the calculator comprises a defined score (range), where the defined score (range) triggers an enhanced reporting or enhanced reporting request; or wherein the calculator comprises a threshold below which the report is enhanced by the score, wherein the threshold is defined for a certain use case.

According to embodiments, the score is associated with an unreported CIR information or with an reported CIR information.

According to embodiments, the transceiver is configured to perform the measurement and/or channel estimation on a selected set of one or more resources (e.g., and a second set of one or more other resource(s)). For example, the device is measuring multiple resources let say on multiple antenna ports. If UE reports more information on port 1 it can provide a score on the similarity of CIR in port 2. Optionally the UE can report a reduced CIR information for port2 which is complementary to the information of port 1. For example, the user equipment may be configured to measure the multiple resource sets (freqs, time snap shots ...) to provide a further reduced CIR compared to a reference CIR or to provide a score w.r.t the reference CIR or to provide an indication which parts (for example segments are associated with the CIR report of the reference resource

According to embodiments, the other resources are associated with measurements on multiple receive antenna ports of the measuring device and/or on multiple transmit antenna ports of the transmission device and/or multiple frequencies and/or time intervals and/or multiple transmit downlink, uplink or sidelink signals.

According to embodiments, the transceiver provide complementary information on the second set of resources in relation to the first set of resources and/or provide indication on the divergence (such as uncommon segments).

According to embodiments, the transceiver is configured to report on the measurement and/or channel estimation on a selected set of one or more resources, and wherein the transceiver is to provide a score for a second set of one or more other resource(s) in wherein the score is calculated based indicative for a reliability or representability of the report of the second or more resource(s) with respect to selected resource.

According to embodiments, the score provides an indication the spatial correlation between the delay or angular components between the two or more selected set of resources.

According to embodiments, the measurement and/or channel estimation comprises power delay profile, channel impulse response, and/or information on delay path and/or angular path to used for Positioning use cases, Channel Sensing, Channel Equalization, and/or Beamforming.

According to embodiments, one or more resources of the reference signal, e.g. a pilot or beacon signal, are included in the assistance data; or wherein the reference signal is included in the assistance data.

According to embodiments, the report configuration message comprises a size information for the CIR information that the report receiving device can handle; or wherein the report configuration message comprises a size information for the CIR information that the report receiving device can handle; wherein the size is identified by an entity, e.g. the report receiving device based on the report receiving device's capability and/or environmental knowledge and/or wherein the size is either a total size of all reports combined or a maximum size of each individual report or a configured static size.

According to embodiments, the transceiver is configured to transmit the report segment-wise in accordance to a report configuration message and/or subdivided into segments having an order being dependent on a relevancy in accordance to a report configuration message. According to embodiments the transceiver is configured to transmit the report on N samples or Nt′ samples corresponding to the measurement composed of Nt′ samples, e. g if the measurement is composed of Nt′ samples of the estimated channel response. Note the timing information for the Nt′ samples may be reported with a timing granularity T, where T=2kxTc. k represents the timing reporting granularity factor. Tc is the basic time unit for NR. Consequently the corresponding measurement (e.g., power if reported) corresponds to the measurement for the reported.

According to embodiments, a segment configuration (of the report configuration message (RC)) or a selection is fixed or could be adapted based on current conditions. In other words, a key feature is that for sample based reporting Nt′ may be fixed for the path-based reporting alternative the UE reports up to Nt′.

A segment is a portion of the CIR that has certain distinctive characteristics. In one example, one segment might include all the multipath components that arrive within a certain time window like the early arriving components w.r. t to a first arriving path and another segment for the later arriving components. In a second example, the segment includes all the samples in a defined CIR window. In another example, one segment could include multipath components above a certain power level or based on the direction of the multipath components. In a different example, a segment can include additional reporting information such as phase or per path pow-er for the identified path while other ents do not necessarily report such information.

These segments could be gapless (or continuous) in the sense that every part of the CIR belongs to some segment. The segments could also be disjoint or non-continuous if the segments are selected based on certain criteria or thresholds, and not all parts of the CIR meet these criteria. The segment configuration or selection can be fixed or could be adapted based on the current conditions. For example, the delay or power thresholds for segment definition based on the current SNR or other channel conditions.

According to embodiments, the report is transmitted using a plurality of segments, wherein the report configuration massage comprises different configurations for different segments.

According to embodiments, the report is transmitted using a plurality of segments, wherein the transceiver applies one segment configuration in one report; alternatively or additionally the report is transmitted using a plurality of segments, wherein the transceiver applies multiple segment configurations in one report.

According to embodiments, the report configuration message comprises or is comprised by a request.

According to embodiments, the report configuration message indicates an adaptability for the report; alternatively or additionally the transceiver is configured to dynamically adapt the content of the report based on an indicated adaptability and/or network conditions (e.g. on factors like Line-of-Sight (LoS) or Signal-to-Interference-plus-Noise Ratio (SINR)), and/or a relevancy (e.g. a score and/or an use case).

According to embodiments, the transceiver is configured to perform a multipath measurement as measurement so as to extract information for the report.

According to embodiments, the transceiver is configured to inform a network entity on measurement capabilities; or wherein the transceiver is configured to inform a network entity on measurement capabilities with respect to the plurality of properties or the plurality of paths.

According to further embodiments additional information provided by the measure, e.g. as channel information can be provided. For example, the UE/TRP request parameter the measurement device continually monitors the current network conditions based on the measurement and identified use cases or application. The measurement device evaluates whether the provided configuration, such as CIR report size, is suitable for the given scenario mainly based on the channel measurements. The measurement device can identify these channel conditions by analyzing the quality of the received signal, the density of paths representing the measurement channel for the one or multiple resources, the type of identified reflecting clusters and/or blockers, or the level of interference.

Accordingly, if the measurement device identifies that the current configuration is inadequate, it sends a feedback message to the network. In one option, the devices notifies the report receiver entity on that provided configuration is not sufficient, such as indicating that the current CIR message size is insufficient. Optionally and depending on the configuration or defined standardized procedure the measurement device may withhold the CIR transmission, if the device determines that the given configuration is insufficient to accurately report the CIR for example the channel size or other parameters do not allow for a comprehensive and accurate CIR representation.

According to embodiments the measurement device can also request an optimized configuration. The device request is based on the device's measurements and identified conditions. The device request can be based on a set of potential configuration provided to the measurement device. In this approach, the device receives in the configuration message a set of applicable configurations the can be requested from the report receiving or coordinator device. For example, the device might request a larger CIR to provide a more detailed representation of the channel. In a second example, the device might identify and request a more efficient (e.g. compressed CIR) configuration for example from the multiple resource or time-snaps.

Based on the feedback and request from the device, the report receiver entity or coordinator adjusts the measurement device's configuration accordingly. The report receiver entity sends an updated configuration profile to the measurement device, or adjusts the parameters (such as transmission parameters like bandwidth or update rate) to better match the device constraints or channel conditions.

According to embodiments, the UE/TRP provides a score for the channel representation with the provided (CIR/PDP/DP) information. In an alternative approach, the measurement device provides a score informing the report receiver entity or coordinator on the representation level reported by the measured CIR. In this method, the device could calculate a ‘score’ that quantifies the difference between the measured the reported CIR. Additionally or alternatively the device can provide the score or representation level for an additional measurement wherein the score represents the difference between the one or multiple CIRs. Wherein the CIR score applies from one or more of the following cases:

The score is associated with an “unreported” CIR information for a given measurement resource or a measurement time interval

The score is associated with the reported CIR information for a given measurement resource or a measurement time interval

For example, the measurement device calculates a score that quantifies the discrepancy between the measured CIR and the reported CIR. This score could be based on a variety of metrics, such as the difference in power levels, delay spread, or number of paths.

The measurement device may report this score separately or/and along with the CIR report to the report receiver entity. The entity uses the network an indication of how well the reported or indicated CIR represents the actual CIR or channel.

The report receiver entity can for example analyzes the score and, if it's below a certain threshold, it may adjust the device's reporting configuration to increase the fidelity of the reports. This could involve increasing the detail level or the size of the reports, or focusing more on certain ‘high-interest’ segments of the CIR.

Accordingly the score information provides the network with more granular control over the CIR reporting process, enabling it to optimize the amount of information received while minimizing the resources used. According to embodiments the transceiver is configured to transmit the report according to a (score) information, e.g. part of the report configuration message to perform granular control on the (CIR) report. Thus, the timing information for the Nt′ samples may be reported with a timing granularity T, where T=2kxTc. k represents the timing reporting granularity factor. Tc is the basic time unit for NR. Consequently the corresponding measurement (e.g., power if reported) corresponds to the measurement for the reported.

According to embodiments, the report configuration message (RC) comprise an indication on a number of samples or segments, e.g. Nt′, and/or on a granular control, e.g. on a value range of integer k for the timing granularity T. For example, the timing information is defined relative to a reference time. Thus, Nt′ and k can be signalled. FFS: the value range of Nt′; the value range of integer k for the timing granularity T.

It also allows the device to play a more active role in managing the network's performance, by providing ongoing feedback on the quality of its reports.

According to embodiments the device detection procedure related to feedback or configuration (adjustable windows and threshold) may be applied. For the UE implementation: the UE utilizes the report configuration to identify the relevant paths, for example based on one of the below principles
Threshold selection: maxLOS FAP; max CIR information, strongest N paths The sampling rate with a given resolution; according to a report config
   Based on that the Ue can select a low threshold (1), a high threshold (2) or an adjustable threshold to enable a window-wise delay path selection procedure
The report config includes at one “path” associated with a multipath
Dealing with “paths clusters” multiple adjacent paths

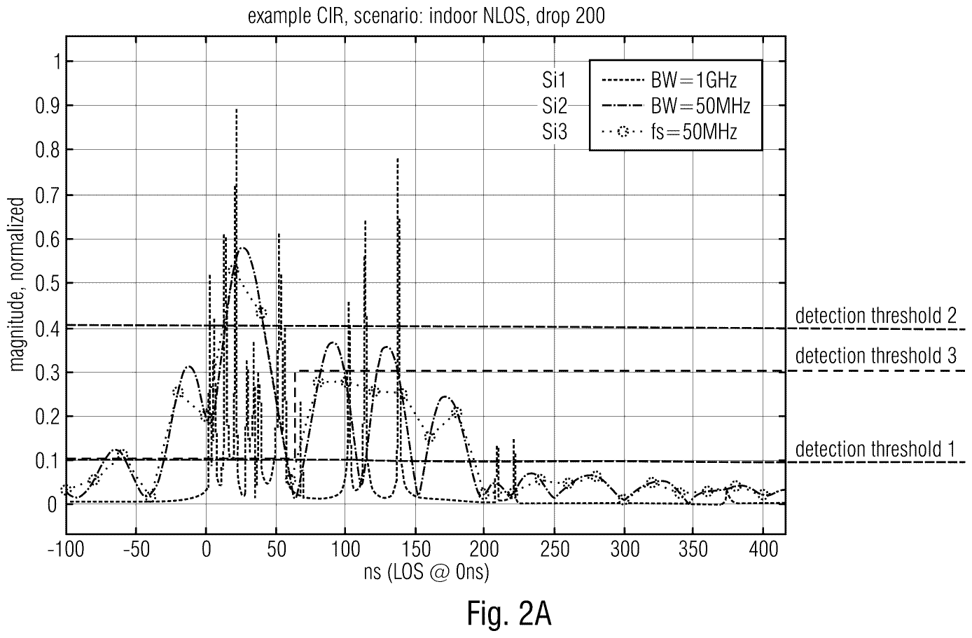

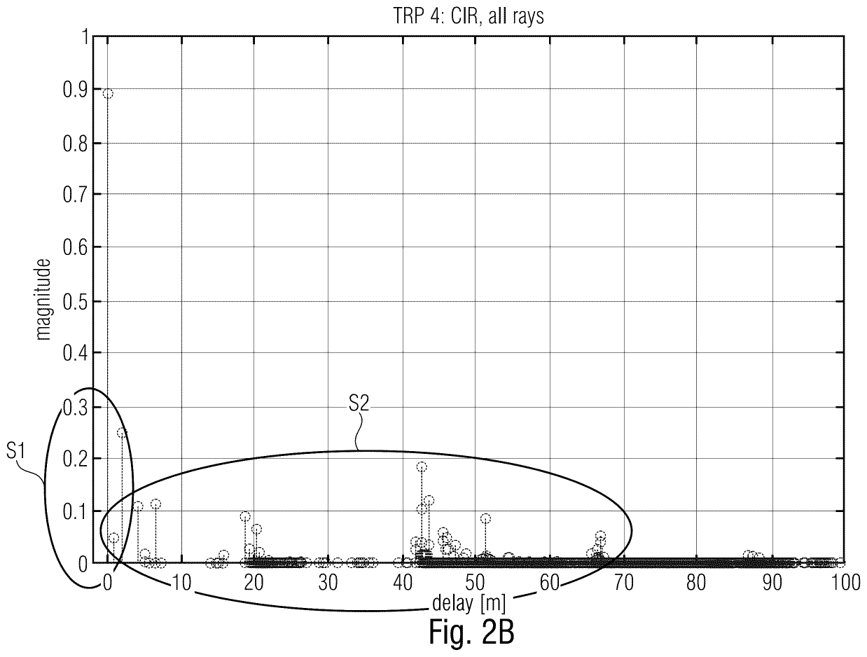

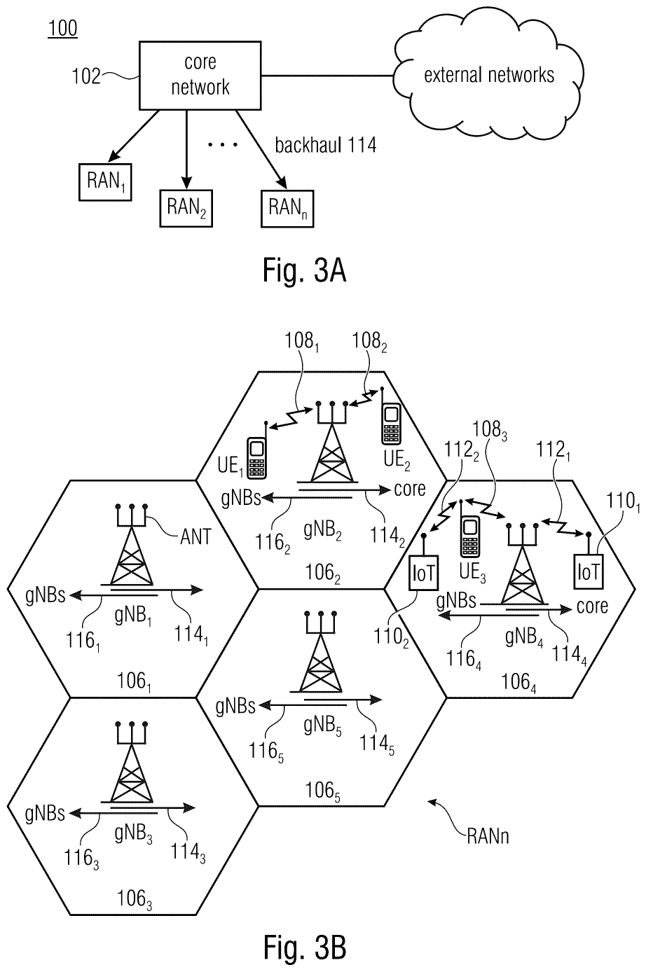

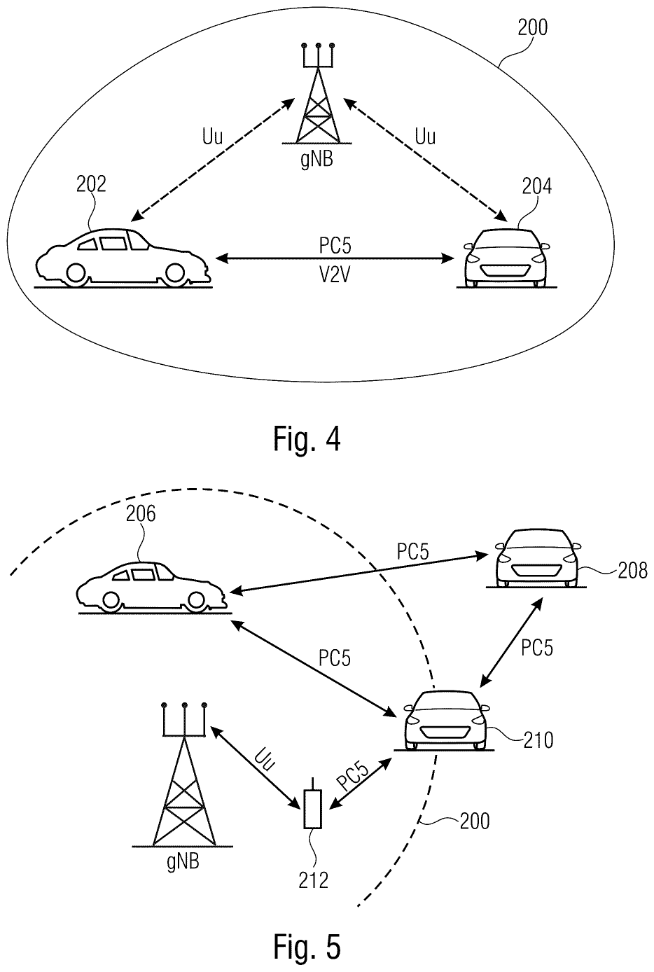

Exemplary thresholds for the detection are illustrated by FIG. 2. FIG. 2a shows a normalized magnitude of a signal (indoor NLOS, drop 200) plotted over the time. In detail, three signals Si1, Si2, Si3, namely having a BW=1 GHz (Si1), BW=50 MHz (Si2) and fs=50 MHz (Si3) are highlighted together with detection threshold 1, detection threshold 2 and detection threshold 3. These thresholds can be used as input/criteria for the reporting and/or for enhancing the report.

According to embodiments and associated resources, report may be used. Here, associating of paths with angular information (example, TRP measures AoA over multiple delays, UE is expected to report similar DL additional paths) may be applied. Here frequency/time snapshots/antennas are relevant. The procedure can be as follows:
UE might be report a detailed CIR and information on the additional paths in the later snaps; define feedback, related with the update rate
Complex around the FAP only
UE might perform measurements on multiple frequencies, or with multiple antennas; it can either report each report separately or use them to utilize a given path or provide feedback on the applied number of ports for the configuration coordination entity
   Report a spatial correlation between the delay or angular components btw multiple frequency or time snapshots and antennas
   Report information on the power level for the delay or angular components btw multiple frequency or time snapshots and antennas

According to embodiments UE measurement assumption may be applied as follows:
Unknowns to the reception (of a report) entity (like LMF)
   UE assumptions (threshold, channel in term of delays, channel in term of variations, resolutions, delay determination approach)
Unknowns to the UE
   Usage (fingerprinting, direct AI/ML, assisted AI/ML)
   Related path selection procedure associating of paths with Angular information (example, TRP measures AoA over multiple delays, Ue is expected to report similar DL additional paths)

According to embodiments, the report configuration may be used in context of AI/ML framework.

FIG. 1b illustrates the exemplary functions performed by the different entities, namely the measuring device 12, the LMF 14, the RS transmitter 16 and the entity providing the report configuration 14′, e.g. implemented into the LMF, in context of a machine learning scenario.

The RS transmitter 16 provides the RS signal in accordance to a RS signal configuration so that the measuring device 12 can perform the measurement (in accordance to the RC). For this the measuring device 12_1 performs demodulation

and/or RS signal detection 12a, (pre-)processing 12_2 so as to output the report 12_3 in accordance to the RC. The report massage RM is received, evaluated (14_1), (pre-)processed (14_2) by the LMF 14 for AI 17a or other applications 17b. like positioning methods.

Apart from the AI/ML model, standard impact may encompass the reference signals (RS), measurements, related reporting and life cycle management (LCM, which includes model updates).

Below the functionality (functional overview) for direct and assisted AI/ML positioning operation will be discussed taking reference to FIG. 1b as example:
1. Signal Generation: whether it's a single or several transmitters 16 (e.g. 16a, 16b and 16c) (TRP for DL-PRS or UE for UL-SRS) generate a reference signal RS on the configured time intervals.
2. Signal Reception and CIR generation: The signal RS is received by one or several receivers 12. This could be a UE 12 (for DL-PRS) or a gNB (for UL-SRS) process into following stages
   a. A demodulator 12_1 may synchronize to the received signal RS and detect the RS. For OFDM based systems the output of the demodulator 12_1 may be presented in the frequency domain (FFT output)
   b. Using the demodulator 12_1 output the receiver derives the channel impulse response (CIR). Different methods or pre-processing (cf. 12_2) may be considered including methods to detect the relevant parts of the CIR. Part of these methods are implementation specific and transparent to the network.
   c. The derived CIR data has to be structured in line with the standardized reporting format (cf. 12_3), which may also be configured specifically for the scenario.
3. Report Evaluation: For network based (including UE assisted methods) positioning applications LMF will receive the measurement report and may in a first step evaluate the report (cf. 14_1). The evaluation can include checks on the availability of sufficient measurements, status information of the measurement (including LOS/NLOS indicator or SINR estimation) and further pre-process 14_2 the data according the input of the AI/ML model 17a.
4. Report Pre-processing 14_2: Depending on the AI/ML input different pre-processing steps may be required. This may include
   a. Reconstruction of the CIR from the reported data
   b. Extract additional information (e.g., delay or direction estimates, cluster information, spatial correlation ...)
   c. Feeding the data to AI/ML model in the case of direct positioning or other positioning methods in the case of assisted AI/ML
5. Beside the AI/ML model 17a other positioning methods 17b operating simultaneously. The AI/ML model 17a may focus on scenarios where other positioning methods are less effective or can provide a limited accuracy. Depending on the received measurements (e.g., sufficient number of LOS signal) the other methods may provide complementary information or even better accuracy.

For example, when it comes to CIR positioning reports, various techniques might be employed, some focusing on pinpointing the crucial segments of the CIR.

According to embodiments, the control 14′ may provide the RS signal configuration for 16 or 12_2 and/or the report configuration RC on 12_3. For this 14′ may consider a request or status of 14.

For example, in concurrent operations of 5G and AI/ML positioning techniques, AI/ML-related measurement reports can benefit non AI/ML methods by complementing existing reports. Based on the evaluation of the reports the LMF will select the optimal positioning method.

According to embodiments, the AI/ML related reporting shall offer sufficient flexibility to allow the reuse of the measurements for other positioning methods.

Referring in the example CIR in FIG. 2b, the early cluster reception obtained from ray-tracing near the LOS path in addition to late clusters are observed. We define Segment 1 marked by S1 (,,early Cluster”) for the early clusters and Segment 2 marked by S2 (,,late Cluster”) for the late clusters. Depending on the channel characteristics, later reflections with varying power levels and K-factors might be evident in other CIR examples.

For Segment 1, which is pivotal for AI/ML-assisted reporting, data surrounding the earliest arrivals is of significance. With accurate information on this segment, the LMF can precisely reconstruct this portion of the CIR. By reporting complex-valued samples, a full CIR reconstruction becomes feasible, ensuring acceptable accuracy including interpolating. This enables different pre-processing or post-processing methods inside the LMF. An example is the analysis of the phase relationship of paths, which may allow to detect the AoA, moving direction or type of cluster (specular reflection or diffuse scatterer). Also LOS/NLOS detection methods may perform better with complex valued data.

As for Segment 2, Power Delay Profile (PDP) details on distinct paths—as identified by the receiver—might suffice for certain applications.

According to embodiments, flexible configurations that emphasize CIR/PDP information, ensuring clear and efficient reporting for varied applications are introduced.

It's should be noted that the current path selection is determined by the UE. The LMF, meanwhile, isn't aware of the criteria or setting applied, such as thresholds or specific path selection mapping to the CIR. It is also unclear (according to Rel-17 additional path reporting) how the UE select or notify the LMF if more paths are measured than the configured CIR/PDP size.

According to embodiments, the transceiver is configured to provide CIR information to be used in the context of AI/ML or for labeling data for AI/ML (in context of this application invaluable when integrated to AI/ML systems, for example the 3GPP AI/ML framework); alternatively or additionally, the transceiver is configured to provide the CIR information to be utilized for one of the following:
Model Training: The reduced CIR information, if associated with a ground truth label, can be used to train supervised learning models or for unsupervised training (i.e. channel charting, channel estimation, assisted positioning for feature or measurement extraction like AoA ToA or channel state). In some examples, the ground truth label might be the actual observed performance, and the UE report and/or feedback would be the input features.
Model Validation: After a model has been trained, the network requests from the UE (or TRP) reduced CIR information to be validated to ensure it's performing well on unseen data. The UE provides the CIR information and associated ground truth labels is used to validate the model's performance.
Model Monitoring: Once deployed, ML models need to be monitored to ensure they continue to perform well as new data comes in. Similarly, the network requests from the UE (or TRP) reduced CIR information to the model, and the model's predictions can be compared against actual outcomes (if available) to monitor the model's performance also in real-time.

In a related aspect, the ground truth label is related to a certain type of network event (like a change in reference or serving cell or a drop in signal quality), the network can configure the reporting UE to focus more on certain segments of the CIR that are most relevant to that event.

Additionally, if certain ground truth labels are rare or particularly important, the network can configure the reporting UE to prioritize reporting CIR information associated with these labels to ensure the ML system gets enough relevant data. According to embodiments associated reporting configuration may be used.

Below further applications according to further embodiments are discussed.

UL-SRS, TDOA based positioning: For TDOA, UL-SRS based positioning the measurements are mainly exchanged between the gNBs and the LMF. For TDOA, UL-SRS based positioning the existing SRS (SRS-pos or normal SRS) can be reused. Accordingly, no or minor RAN1 specification impact is expected. Possible enhancements of the SRS (support parallel multiport transmissions for the SRS-pos also, for example) may be useful for positioning applications also.

UE based positioning using the DL-PRS (OTDOA): For UE based positioning (using AI/ML) the measurements and reporting is UE internal and implementation specific. Only LCM related questions are applicable to this positioning method.

Network based positioning using the DL-PRS (OTDOA): In this case the UE reports the measurements to the LMF. An efficient reporting of the measurements reduces the reporting overhead. The reporting overhead depends on
Word length (number of bits per value, integer or floating point, normalization yes/no, linear or non-linear (log(x) instead of x), for example), . . . )
CIR length
Complex valued (or magnitude and phase) versus magnitude only

A straightforward approach is the “truncated CIR” approach. In this case the relevant part (or parts) of the CIRs are reported together with related parameter (e.g., position if the first sample of the reporting window, normalization parameter (power or peak value, for example)). Using complex valued samples allows a reconstruction of the full CIR with an acceptable accuracy including interpolation, for example. This enables different pre-processing or post-processing methods inside the LMF. An example is the analysis of the phase relationship of paths, which may allow to detect the AoA, moving direction or type of cluster (specular reflection or diffuse scatterer). Also LOS/NLOS detection methods may perform better with complex valued data.

RTT based solutions: In this case each entity is a transmitter and a receiver. The main advantage of RTT is the low sensitivity to non-ideal synchronization (including efficient support of sequential measurements with non-ideal frequency offset estimation).

Assuming non-synchronized or partial synchronized networks the TDOA information (relative time difference of arrival) may be lost. Accordingly, the measured CIR or PDP reporting may be no longer aligned to a common reference point. In this case the CIR or PDP characteristics relative to the first arriving (first detected) path can be used as fingerprint (together with the RTT measurement).

Below an example scenario will be discussed
UE configured to measure on a given reference signal based on received configuration or from sensing with a BW selected according to sensing Rx BW or/and according Tx BW of the received signal
It could happen that the receiver applies a higher RX Bw (or sampling rate) for the one or more resources, this can be in the case when the multiple transmitters apply different Tx resource configurations
UE configured according to a report configuration including an expected delay paths for example a maximum number of the paths
Environmental information
The device can detect/identify characteristic (statistical or behavioral) of a scattering model; the UE can provide feedback on the identified components so that the LMF identify the scatterere impact on the CIR
Identify common clusters in the CIR of associated with multiple resources

Above embodiments have been discussed with focus on the measurement entity. Below, embodiments referring to the network entity providing/adapting the report configuration message will be discussed.

According to embodiments, the network entity is configured to perform positioning determination and/or channel sensing and/or training a model using Artificial Intelligence.

According to embodiments, the report configuration is dependent on a current network condition or a current use case.

According to embodiments, the report configuration comprises an information on a power delay profile, channel impulse response, and/or information on delay path and/or angular path to used for Positioning use cases, Channel Sensing, Channel Equalization, and/or Beamforming; alternatively or additionally, report configuration message comprises a size information for the CIR information that the report receiving device can handle.

According to embodiments, the report configuration is adapted on a feedback or score.

According to embodiments, network entity is configured to configure the reporting UE to focus more on certain segments or samples of the CIR that are most relevant to an event, like a network event (e.g. a change in reference or serving cell or a drop in signal quality) to be used for machine learning.

Sample-based measurement is defined as:
The measurement is composed of Nt′ samples of the estimated channel response in time domain. The timing information for the Nt′ samples are reported with a timing granularity T, where T=2kxTc. k represents the timing reporting granularity factor. Tc is the basic time unit for NR. The corresponding measurement (e.g., power if reported) corresponds to the measurement for the reported Nt′ samples.
Nt′ and k can be signalled. FFS: the value range of Nt′; the value range of integer k for the timing granularity T. The timing information is defined relative to a reference time

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

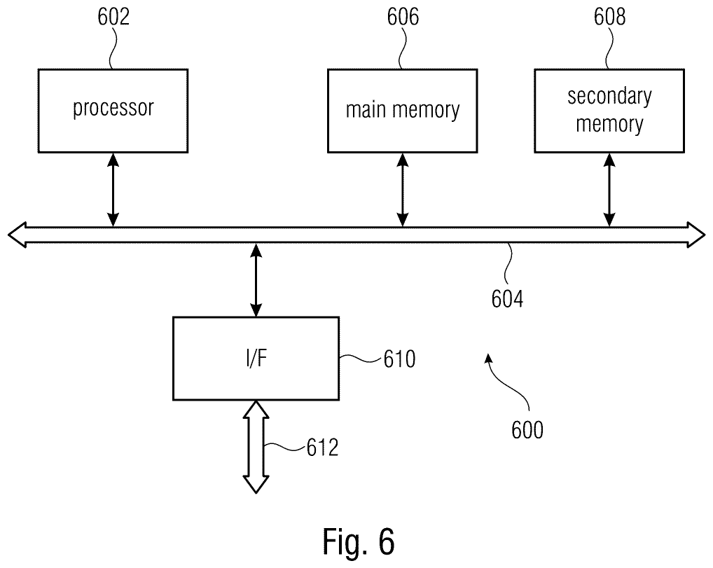

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 6 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. User equipment comprising:
a transceiver configured to perform a measurement and/or channel estimation on a reference signal with respect to a plurality of properties, especially with respect to a plurality of paths;
wherein the user equipment is configured to receive a report configuration message;
wherein the transceiver is configured to report on the measurement and/or channel estimation by use of a report, wherein the report is reduced to one or more limited and/or defined properties and/or paths in accordance to the report configuration message.

2. User equipment according to claim 1, wherein the user equipment is configured to select and report relevant parts of the measurement according to parameter(s) received from a network entity.

3. User equipment according to claim 1, wherein the reference signal received by the transceiver comprises multipath reception signal including at least one additional path.

4. User equipment according to claim 1, wherein the report configuration message includes information on the plurality of paths and/or on the number of paths and/or further information than the number of paths.

5. User equipment according to claim 1, wherein the report comprises the measurement and/or the channel estimation for at least one additional path associated with a multipath reception.

6. User equipment according to claim 5, wherein the user equipment estimates a channel impulse response, CIR, and wherein a configuration parameter for selecting the relevant parts of the measured CIR includes one or several of following parameters:
path power
path power relative to noise power
power of a group of paths (group of paths=cluster)
ratio between peak value to average value within a configurable averaging length
delay and/or delay range
delay spread
path power relative to a slope of the power delay profile
type of power delay profile and related parameter
type of cluster.

7. User equipment according to claim 1, wherein the transceiver configured to perform the measurement and/or channel estimation on the reference signal with respect to at least two, three or more paths; and/or
wherein the transceiver configured to select a reduced number of paths for the report based on criteria, like cluster of paths.

8. User equipment according to claim 1, wherein the transceiver is configured to perform a multiple measurements on certain segments or samples; and/or
wherein the transceiver is configured to perform sample-based measurements or sample-based measurements where the timing information is an integer multiple of sampling periods; and/or
wherein the transceiver is configured to perform path-based measurements or path-based measurement, where the timing information is according to the detected path timing and may not be an integer multiple of sampling periods.

9. User equipment according to claim 1, wherein the user equipment sorts multipath components based on delay and/or angle properties.

10. User equipment according to claim 9, wherein components with similar delays and angles are grouped together; and/or
wherein the transceiver is configured to sort the components into clusters.

11. User equipment according to claim 8, wherein the transceiver is configured to track cluster properties over multiple measurement instants.

12. User equipment according to claim 8, wherein the transceiver is configured to adapt its cluster and/or path estimation reporting based on the identified clusters and/or Doppler shift; and/or
wherein the transceiver is configured to continually update a channel estimation, cluster identification, and tracking processes to keep up with any changes in an environment.

13. User equipment according to claim 1, wherein each path or additional path is represented by parameter(s) including at least one of the following:
delay,
angle of arrival,
angle of departure,
power;
and phase information.

14. User equipment according to claim 1, wherein the transceiver is configured to apply thresholding to select multipath components above a certain threshold.

15. User equipment according to claim 1, wherein the transceiver is configured to select one or more peaks associated with the strongest paths to represent the cluster.

16. User equipment according to claim 1, wherein the transceiver is configured to average and/or sum properties of the measured paths within each cluster to estimate overall properties of the cluster.

17. User equipment according to claim 1, wherein the transceiver is configured to fit a model to represent a given cluster.

18. User equipment according to claim 1, wherein the transceiver is configured to provide additional measurements, like variance to indicate a spread in delay, angle, power and/or phase for the identified components.

19. User equipment according to claim 1, wherein the transceiver is configured to identify cluster lifetime and to account a dynamic environment in the report according to configuration and/or according to report size.

20. User equipment according to claim 1, wherein the transceiver is configured to identify the changes in cluster and to account the dynamic environment in the report according to configuration.

21. User equipment according to claim 1, wherein the transceiver configured to reduce content, especially a number of paths for the report, based on criteria comprising:
paths being likely to be the strongest and most reliable;
delay spread, e.g. paths comprising most significant delay spread;
directionality, e.g. paths comprising most consistent directionality;
frequency response, paths comprising most consistent frequency response;
channel correlation, e.g. paths correlating with each other;
cluster of paths.

22. User equipment according to claim 1, wherein the report comprises information related to missing or unreported property or parts.

23. User equipment according to claim 1, wherein the transceiver comprises a calculator configured to determine feedback whether the report configuration of the report configuration message is sufficient for reporting on the current situation, e.g. network condition or measurement capability; and/or for a determined reliability or representability.

24. User equipment according to claim 1, wherein the transceiver is configured to request a different repot configuration or repot configuration included by the report configuration message or a report configuration out a set of report configurations or a larger CIR.

25. User equipment according to claim 1, wherein the transceiver comprises a calculator configured to calculate a score indicative for a reliability or representability of the report for a total measurement and/or channel estimation; or
wherein the transceiver comprises a calculator configured to calculate a score indicative for a reliability or representability of the report for a total measurement and/or channel estimation and wherein the report comprises a score.

26. User equipment according to claim 1, wherein the calculator comprises a threshold for the score below which the report is enhanced by the score; or
wherein the calculator comprises a defined score (range), where the defined score (range) triggers an enhanced reporting or enhanced reporting request; or
wherein the calculator comprises a threshold below which the report is enhanced by the score, wherein the threshold is defined for a certain use case.

27. User equipment according to claim 1, wherein the score is associated with an unreported CIR information or with an reported CIR information.

28. User equipment according to claim 1, wherein the transceiver is configured to perform the measurement and/or channel estimation on a selected set of one or more resources; and/or
wherein the user equipment is configured to measure multiple resource sets, especially including frequency, time snap shots ..., to provide a further reduced CIR compared to a reference CIR or to provide a score w.r. t the reference CIR or to provide an indication which parts, especially segments are associated with a CIR report of a reference resource.

29. User equipment according to claim 28, wherein other resources are associated with measurements on multiple receive antenna ports of a measuring device and/or on multiple transmit antenna ports of a transmission device and/or multiple frequencies and/or time intervals and/or multiple transmit downlink, uplink or sidelink signals.

30. User equipment according to claim 28, wherein the transceiver provide complementary information on the second set of resources in relation to the first set of resources and/or provide indication on a divergence, such as uncommon segments.

31. User equipment according to claim 1, wherein the transceiver is configured to report on the measurement and/or channel estimation on a selected set of one or more resources, and wherein the transceiver is to provide a score for a second set of one or more other resource(s) in wherein the score is calculated based indicative for a reliability or representability of the report of the second or more resource(s) with respect to selected resource.

32. User equipment according to claim 25, wherein the score provides the indication a spatial correlation between the delay or angular components between the two or more selected set of resources.

33. User equipment according to claim 1, wherein the measurement and/or channel estimation comprises power delay profile, channel impulse response, and/or information on delay path and/or angular path to used for Positioning use cases, Channel Sensing, Channel Equalization, and/or Beamforming.

34. User equipment according to claim 1, wherein one or more resources of the reference signal, like a pilot or beacon signal, are included in assistance data; or
wherein the reference signal is included in the assistance data.

35. User equipment according to claim 1, wherein the report configuration message comprises a size information for the CIR information that the report receiving device can handle; or
wherein the report configuration message comprises a size information for the CIR information that the report receiving device can handle; wherein the size is identified by an entity, e.g. the report receiving device based on the report receiving device's capability and/or environmental knowledge and/or wherein the size is either a total size of all reports combined or a maximum size of each individual report or a configured static size.

36. User equipment according to claim 1, wherein the transceiver is configured to transmit the report segment-wise in accordance to a report configuration message and/or subdivided into samples or segments having an order being dependent on a relevancy in accordance to a report configuration message; and/or
wherein the transceiver is configured to transmit the report on N samples or Nt′ samples corresponding to the measurement composed of Nt′ samples; and/or
wherein segment configuration or selection is fixed or adapted based on current conditions.

37. User equipment according to claim 1, wherein the report is transmitted using a plurality of samples or segments, wherein the report configuration massage comprises different configurations for different segments.

38. User equipment according to claim 1, wherein the transceiver is configured to transmit the report according to an information, especially an information as part of the report configuration message, to perform granular control on the, CIR, report; and/or
wherein the report configuration message comprise an indication on a number of samples or segments, e.g. Nt′, and/or on a granular control, e.g. on a value range of integer k for the timing granularity T.

39. User equipment according to claim 1, wherein the report is transmitted using a plurality of samples or segments, wherein the transceiver applies one segment configuration in one report; and/or
wherein the report is transmitted using the segments, wherein the transceiver applies multiple segment configurations in one report.

40. User equipment according to claim 1, wherein the report configuration message comprises or is comprised by the request.

41. User equipment according to claim 1, wherein the report configuration message indicates an adaptability for the report; and/or
wherein the transceiver is configured to dynamically adapt the content of the report based on an indicated adaptability and/or network conditions or Signal-to-Interference-plus-Noise Ratio (SINR)), and/or the relevancy.

42. User equipment according to claim 1, wherein the transceiver is configured to perform a multipath measurement as measurement so as to extract information for the report.

43. User equipment according to claim 1, wherein the transceiver is configured to inform the network entity on measurement capabilities; or wherein the transceiver is configured to inform the network entity on measurement capabilities with respect to the plurality of properties or the plurality of paths.

44. User equipment according to claim 1, wherein the transceiver is configured to provide CIR information to be used in a context of AI/ML this application invaluable when integrated to AI/ML systems, for example a 3GPP AI/ML framework; and/or
wherein the transceiver is configured to provide the CIR information to be utilized for one of the following:
Model Training: The reduced CIR information, if associated with a ground truth label, can be used to train supervised learning models or for unsupervised training (i.e. channel charting, channel estimation, assisted positioning for feature or measurement extraction like AoA ToA or channel state). In some examples, the ground truth label might be an actual observed performance, and the user equipment report and/or feedback would be input features;
Model Validation: After the model has been trained, network requests from the user equipment reduced CIR information to be validated to ensure it's performing well on unseen data. The user equipment provides the CIR information and associated ground truth labels is used to validate the model's performance;
Model Monitoring: Once deployed, ML models need to be monitored to ensure they continue to perform well as new data comes in. Similarly, the network requests from the user equipmentreduced CIR information to the model, and the model's predictions can be compared against actual outcomes (if available) to monitor the model's performance also in real-time.

45. Transmission Point, TRP comprising:
a transceiver configured to perform a measurement and/or channel estimation on a reference signal with respect to a plurality of properties, especially with respect to a plurality of paths;
wherein the TRP is configured to receive a report configuration message;
wherein the transceiver is configured to report on the measurement and/or channel estimation by use of a report, wherein the report is reduced to one or more limited and/or defined properties and/or paths in accordance to the report configuration message.

46. Network entity comprising:
a transceiver configured to receive a report on a measurement and/or channel estimation on a reference signal with respect to a plurality of properties, especially with respect to a plurality of paths, wherein the report is reduced to one or more limited and/or defined properties and/or paths in accordance to a report configuration message,
wherein the transceiver is configured to provide the report configuration message.

47. Network entity according to claim 46, wherein the network entity is configured to perform positioning determination and/or channel sensing and/or training a model using Artificial Intelligence.

48. Network entity according to claim 46, wherein the report configuration is dependent on a current network condition or a current use case.

49. Network entity according to claim 46, wherein the report configuration comprises an information on a power delay profile, channel impulse response, and/or information on delay path and/or angular path to used for Positioning use cases, Channel Sensing, Channel Equalization, and/or Beamforming; and/or
wherein report configuration message comprises a size information for a CIR information that the report receiving device can handle.

50. Network entity according to claim 46, wherein the report configuration is adapted on a feedback or score.

51. Network entity according to claim 46, wherein network entity is configured to configure the reporting user equipment to focus more on certain segments of the CIR that are most relevant to an event, like a network event or a change in reference or serving cell or a drop in signal quality to be used for machine learning.

52. Communication system comprising a user equipment according to claim 1 or TRP according to claim 45 and a network entity according to claim 46.

53. Method for operating a user equipment, comprising the steps of:
performing a measurement and/or channel estimation on a reference signal with respect to a plurality of properties, especially with to a plurality of paths;
receiving a report configuration message;
reporting on the measurement and/or channel estimation by use of a report, wherein the report is reduced to one or more limited and/or defined properties and/or paths in accordance to the report configuration message.

54. Method for operating a network entity or user equipment, comprising the steps of:
receiving a report on the measurement and/or channel estimation on a reference signal with respect to a plurality of properties, especially with to a plurality of paths, wherein the report is reduced to one or more limited and/or defined properties and/or paths in accordance to a report configuration message; and
providing the report configuration message.

55. Computer program for performing the method according to claim 53, when running on a computer.
